(19) United States
(12) Patent Application Publication
(10) Pub. No.: US 2009/0125790 A1
(43) Pub. Date: May 14, 2009

(54) Method and Apparatus of Automatically Selecting Error Correction Algorithms by a NAND Flash Controller

(75) Inventors: Sree M. Iyer, San Jose, CA (US); Arunprasad Ramiya Mothilal, Santa Clara, CA (US); Santosh Kumar, Santa Clara, CA (US)

Correspondence Address: The TPL Group, 20400 Stevens Creek Blvd., Fifth Floor, Cupertino, CA, 95014, US

(73) Assignee: MCM PORTFOLIO LLC, Cupertino, CA (US)

(21) Appl. No.: 11/939,499

(22) Filed: Nov. 13, 2007

(51) Int. Cl. G06F 11/14

(52) U.S. Cl. 714/773; 714/E11.112

(57) ABSTRACT

A method and apparatus of automatically selecting an optimal ECC algorithm by NAND Flash controller to detect and correct errors to read or write data from or to a flash memory device is described. In one embodiment, the method includes selecting the optimal algorithm by identifying the characteristics of the target flash memory device such as but not limited to redundant data size. The method also includes determining the optimal algorithm based on the application stored in the target flash memory device.

### COPYRIGHT NOTICE/PERMISSION

A portion of the disclosure of this patent document contains material which is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD OF THE INVENTION

The field of invention relates generally to flash media and more specifically, but not exclusively, to verifying data stored in flash memory, and other memory, devices and correcting errors.

### BACKGROUND

Flash memories have become the technology of choice for long term storage applications because of their outstanding performance in data-dense applications that require low cost per bit and fast write times. Flash memory devices store information in an array of floating gate transistors called cells. The density of the flash memory devices is increased by shrinking the memory cells and reducing the number of electrons stored in the cell. These devices utilize single level cell (SLC) technology, in which each cell stores only one bit of information, and multiple level cell (MLC) technology, where more than one bit per cell is stored. Even though flash memory devices offer various advantages, the use of the flash memory devices in applications requiring high data integrity is limited because of yield constraints, wear of the memory cells from multiple write-erase cycles, changing of write characteristics of cells because of coupling between adjacent floating gates, and random change of memory data bits values from ‘1’ to ‘0’ (bit flipping). To minimize these problems, data stored in a flash memory device need to be verified and corrected for errors.

Error correction code (ECC) that is utilized by a flash controller to detect and correct errors in flash memory can depend on various factors, such as, but not limited to, the level cell technology (single or multiple), the process technology used by the manufacturer to design the flash memory, redundant memory bytes provided per page by the manufacturer, and the application that uses data stored in the flash memory. For example, SLC flash memory devices provide higher data integrity than MLC flash devices. SLC flash devices currently need only single bit error correction code per 512 bits where as MLC flash devices require four bit error correction code per 512 bits. As new generation flash memories constitute reduced cell size and decreased oxide thickness, the number of errors, and the number of error correction bits required, almost doubles for MLC flash devices. That is, a factor that affects the selection of error correction code is the process technology used to manufacture the flash memory devices.

Another factor that affects the number of ECC bits required is the application stored in the flash memory. Data stored in memory either implement or manipulate data (for example software programs) for various tasks associated with different applications. Each application requires different level of data reliability to perform its required tasks. For example, flash memory devices storing graphic data are not required to provide high data reliability as the error bits do not have significant impact on the graphic output. On other hand, flash memory devices storing information related to public safety or financial applications need to provide high data reliability.

Flash controllers implement ECC algorithms to detect and correct errors in data stored in flash memory. In conventional systems, the flash controller has one ECC controller to detect and correct errors in a particular type of flash memory device, thus limiting the user to only certain type of flash memory. As flash memory devices are replacing the hard drives in the long term storage applications, multiple flash memory devices of different process technologies and cell level architectures may be required. The present invention includes a mechanism to select dynamically an ECC algorithm from a plurality of ECC algorithms based on the target flash memory device taking into consideration the yield of the flash memory device and the application that utilizes data stored in the flash memory.

### SUMMARY OF THE INVENTION

A method and apparatus of automatically selecting an optimal ECC algorithm by NAND Flash controller, or other controller, to detect and correct errors to read or write data from, or to, a flash memory device, or other memory device, is described. In one embodiment, the method includes selecting the optimal algorithm by identifying the characteristics of the target flash memory device such as but not limited to redundant data size. The method also includes determining the optimal algorithm based on the application stored in the target flash memory device. As used in this specification and claims, references to flash controller encompasses other controllers employed to detect and correct errors to read or write data from, or to, other memory device. As used in this specification and claims, references to flash memory encompasses other types of memory device.

In one embodiment, the apparatus includes a state machine to decode the characteristics of the active flash memory devices and determine the optimal ECC algorithm to encode and decode data. The apparatus also includes an ECC controller that has a plurality of ECC algorithms, as well as encoder and decoder circuits to encode and decode data prior to writing or reading from flash memory devices. The plurality of the ECC algorithms encode and decode data differently based on different characteristics of different flash memory devices.

The details of the present invention, both as to its structure and operation, and many of the attendant advantages of this invention, can best be understood in reference to the following detailed description, when taken in conjunction with the accompanying drawings, in which like reference numerals refer to like parts throughout the various views unless otherwise specified, and in which:

### BRIEF DESCRIPTION OF THE DRAWINGS

FIG. 1 is a block diagram of the present invention.

FIG. 2 illustrates the components of a flash controller and interface between the flash controller and flash memory devices.

FIG. 3 illustrates the operation of the flash controller in one embodiment where the flash controller writes data to one of the flash memory devices.

FIG. 4 illustrates the operation of the flash controller in one embodiment where the flash controller receives a command from the memory interface to read data from one of the flash memory devices.

FIG. 5 illustrates the operation of the flash controller, in one embodiment, of the flash controller detection process.

FIG. 6 illustrates the operation of the flash controller, in one embodiment where the flash controller selects a preferred ECC algorithm based on an application.

### DETAILED DESCRIPTION OF THE PREFERRED EMBODIMENTS

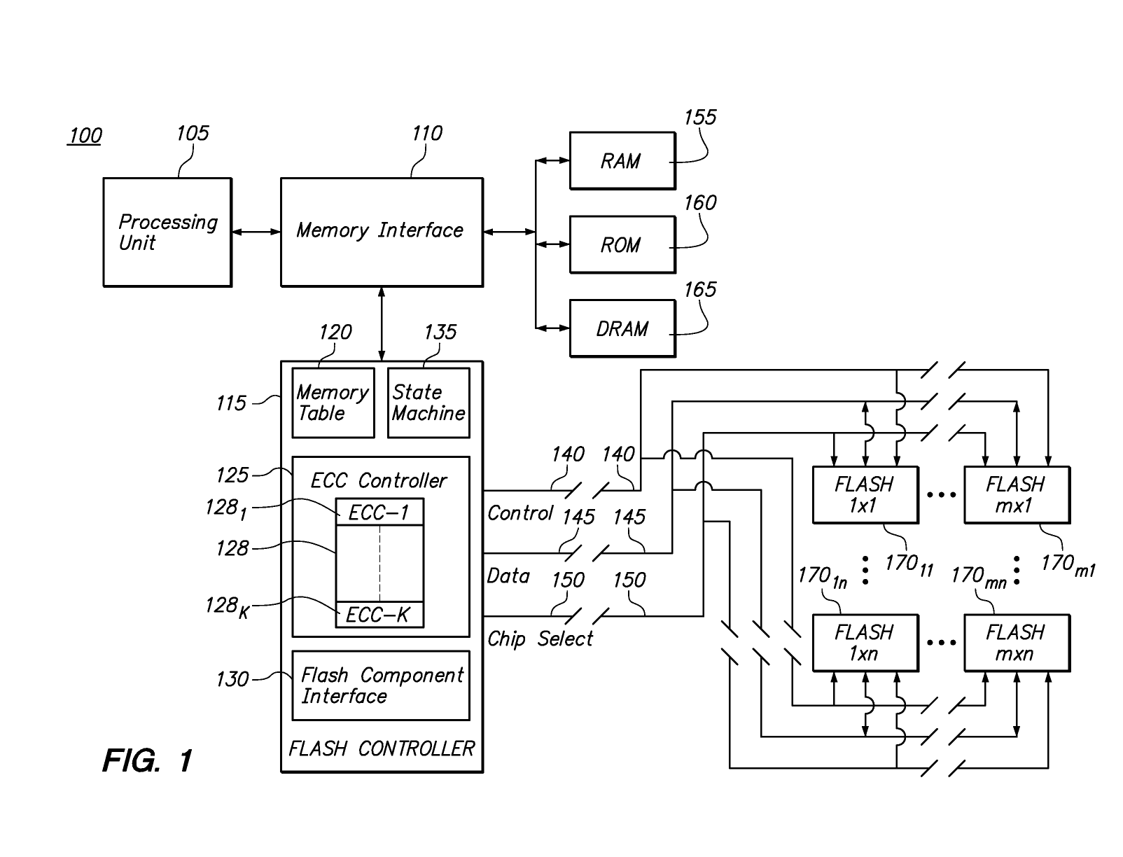

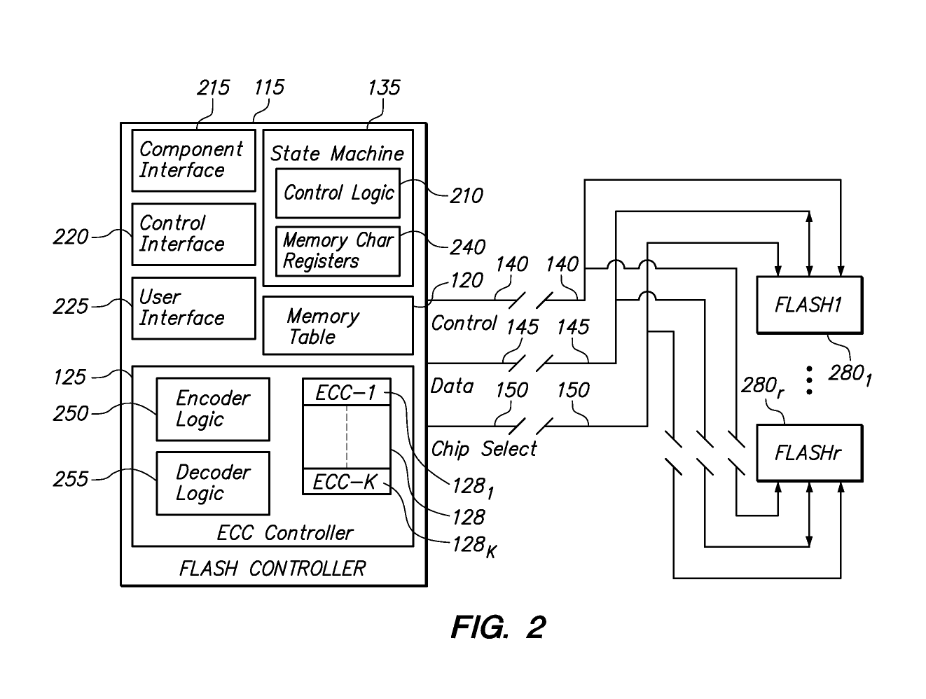

FIG. 1 shows the block diagram of the present invention in a system 100, which includes a CPU 105, memory interface 110 coupled to the CPU 105, memory devices such as random access memory RAM 155, read only memory ROM 160, dynamic random access memory 165 and flash controller 115. The flash controller 115, which is depicted in detail in FIG. 2, includes memory table 120, state machine 135, error correction code controller 125 and flash component interface 130. The state machine 135 is coupled to the error correction code (FCC) controller 125 and the memory interface 110. In one embodiment, the ECC controller 125 includes a table of algorithms 128, including multiple ECC algorithms ECC-1 to ECC-k (128₁ to 128ₖ), that are activated by the state machine 135 based on the control signals received from the flash controller 115. The flash controller 115 transfers data to and from the flash memory devices 170₁₁ to 170₁ₙ and 170ₘ₁ to 170ₘₙ using the flash component interface 130.

In one embodiment, the CPU 105 may instruct the memory interface 110 to write data to or read data from one or more of the flash memory devices 170₁₁ to 170₁ₙ and 170ₘ₁ to 170ₘₙ using the flash controller 115. Flash controller 115, on receiving the command from the memory interface 110, activates the chip select signal 150 to identify flash memory devices 170₁₁ to 170₁ₙ and 170ₘ₁ to 170ₘₙ that are currently active. On detecting active flash memory devices 170₁₁ to 170₁ₙ, and 170ₘ₁ to 170ₘₙ, the flash controller 115 transmits the command to the flash memory devices 170₁₁ to 170₁ₙ and 170ₘ₁ to 170ₘₙ, using control signals 140, and data signals 145, to determine the Device ID of the active flash memory device 170₁₁ to 170₁ₙ and 170ₘ₁ to 170ₘₙ. The flash controller 115 communicates with the flash memory devices 170₁₁ to 170₁ₙ and 170ₘ₁ to 170ₘₙ using data signals 145, chip select signal 150 and the control signals 140. The control signals 140 may include, but are not limited to, read signal, write signal, command enable latch and address enable latch signal. The flash controller 115 decodes the Device ID to determine the characteristic of the active flash memory device. The characteristics of the flash memory devices 170₁₁ to 170₁ₙ and 170ₘ₁ to 170ₘₘ include, but are not limited to, page size, block size, spare [**?space**] size, and organization. In one embodiment, the logic needed to decode the Device ID is available in the memory table 120, in the state machine 135, or may be provided by an external device such as, but not limited to, EEPROM. The flash controller 115 commands the state machine 135 to generate a signal to select the ECC algorithm from the table of ECC algorithms 128 ECC-1 to ECC-k (128₁ to 128ₖ) based on the characteristics of the active flash memory device (selected from 170₁₁ to 170₁ₙ and 170ₘ₁ to 170ₘₙ).

FIG. 2 illustrates in more detail different components of flash controller 115 and interface between the flash controller 115 and flash memory devices 280₁ to 280ᵣ. The flash controller 115 includes ECC controller 125, state machine 135, flash component interface 215, control interface 220, user interface 225, and memory table 120. The flash component interface 215 is a means of communication between the flash controller 115 and the flash memory devices 280₁ to 280ᵣ. Control interface 220 generates control signals required to transfer data between the flash controller 115 and the flash memory devices 280₁ to 280ᵣ. State machine 135 further includes control logic circuit 135 to generate the control signals that in turn select the appropriate algorithm, chosen from ECC-1 to ECC-k (128₁ to 128ₖ), and memory characteristic registers 240, that store flash memory device characteristics. The flash memory device characteristics may include but are not limited to page size, block size, and redundant data size. On receiving a command from the CPU 105 (FIG. 1), the flash memory controller 115 activates chip select signal 150 to detect if any of the flash memory devices 280₁ to 280ᵣ are currently active. In case of detecting any active flash memory device, the flash controller utilizes the control signals 140 and data signals 145 to determine the active flash memory device ID. The state machine 135 utilizes information available in the memory characteristic registers 240 to identify the appropriate ECC algorithm based on the characteristics of the flash memory devices 280₁ to 280ᵣ (shown in further detail in the following table 1):

TABLE 1
Example Flash Memory Device Characteristics

| | | | Redundant | | ECC |
|---|---|---|---|---|---|
| Device ID | Page Size | Block Size | Data Size | Application | Algorithm |
| ID-1 | 2K | 164K | 6 Bytes | APP-1 | ECC-1 |
| ID-2 | 4K | 128K | 8 Bytes | APP-2 | ECC-2 |
| ID-r | 8K | 256K | 12 Bytes | APP-i | ECC-j |

Table 1 shows the constraints utilized by the state machine 135 in decoding the flash memory device characteristics and identifying the appropriate ECC algorithm, chosen from ECC-1 to ECC-k (128₁ to 128ₖ). In Table 1, for explanation purposes, assumptions are made that the flash controller 115 determines the appropriate ECC algorithm, chosen from ECC-1 to ECC-k (128₁ to 128ₖ), with respect to page size, block size, and redundant data size. If state machine 135 receives a command from the flash controller 115 to determine the preferred algorithm, chosen from ECC-1 to ECC-k (128₁ to 128ₖ), for flash memory device 280₁ with a device ID of ID-1, it utilizes the flash memory characteristics information available in the memory characteristic registers 240 to decode the flash memory device ID. In one embodiment, state machine 135 uses redundant data size information to determine the preferred ECC algorithm, chosen from ECC-1 to ECC-k (128₁ to 128ₖ), of the targeted flash memory device, one of 280₁ to 280ᵣ. For example, in the earlier case where the flash memory device 280₁ where device ID is ID-1, the state machine 135 would identify the ECC algorithm ECC-1, 128₁, to be used to encode or decode data that will be written to or read from the flash memory device, one of 280₁ to 280ᵣ. State machine 135 utilizes control logic circuit 210 to store the flash memory device information and the preferred ECC algorithm in the memory table 120.

TABLE 2
Example Memory Table

| Memory Device | ECC Algorithm |
|---|---|
| Flash-1 | ECC-1 |
| Flash-2 | ECC-2 |
| Flash-r | ECC-j |

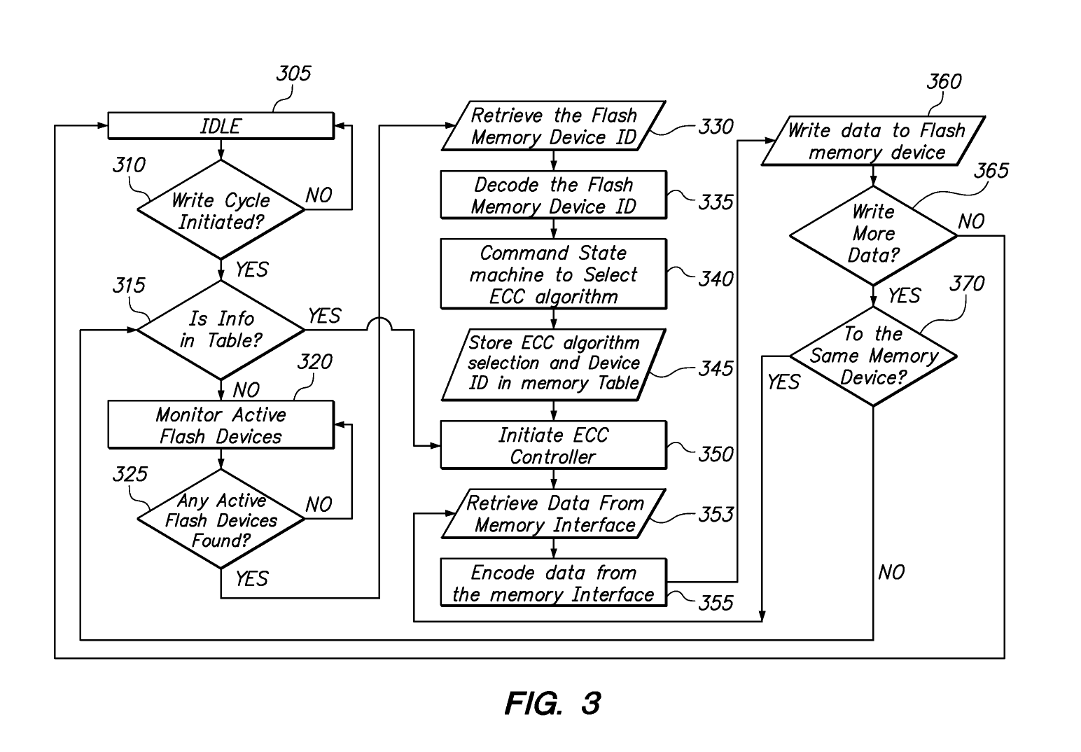

The state machine 135, after determining the preferred ECC algorithm, chosen from ECC-1 to ECC-k (128₁ to 128ₖ) for each flash memory device, stores data in the memory table 120. The flash controller 115 on receiving a read or write command from the CPU 105 (FIG. 1) verifies that information regarding the target flash memory device, one of 280₁ to 280ᵣ and the preferred algorithm are available in the memory table 120 before enabling the memory detection process (shown in detail in FIGS. 3, 4, and 5).

The control logic circuit 210 also enables the ECC controller 125 to encode or decode data. The ECC controller 125 incorporates a table of multiple ECC algorithms 128, ECC-1 to ECC-k (128₁ to 128ₖ), encoder logic circuit 250, and the decoder logic circuit 255. The encoder circuit 250 utilizes ECC algorithms ECC-1 to ECC-k (128₁ to 128ₖ) to encode data that needs to be written to flash memory devices. The decoder circuit 255 utilizes ECC-1 to ECC-k (128₁ to 128ₖ) to detect and correct errors in data read from the flash memory devices 280₁ to 280ᵣ.

In one embodiment, the encoder logic circuit 250 may consist of plurality of circuits that can be enabled based on the ECC algorithms ECC-1 to ECC-k (128₁ to 128ₖ). Similarly, the decoder logic circuit 255 may consist of plurality of circuits that can be enabled based on the ECC algorithms ECC-1 to ECC-k (128₁ to 128ₖ).

FIG. 3 illustrates the operation of the flash controller 115 in one embodiment where the flash controller 115 receives a command from the CPU 105 (FIG. 1) to write data to one of the flash memory devices 280₁ to 280ᵣ (FIG. 2). On receiving power, the flash controller 115 can be programmed to operate in idle state (step 305). The flash controller 115 verifies that the CPU 105 initiated the write cycle 310 on a timely basis. When the CPU 105 initiates write cycle 310, then the flash controller 115 determines if information regarding the active flash memory device, 280₁ to 280ᵣ and the preferred ECC algorithm, chosen from ECC-1 to ECC-k (128₁ to 128ₖ), is available in the memory table 120 (step 315). If information regarding the active flash memory device 280₁ to 280ᵣ and the preferred ECC algorithm, chosen from ECC-1 to ECC-k (128₁ to 128ₖ), is available in the memory table 120, then the flash controller 115 initiates the ECC controller 245 (step 350). If the information is not available in the memory table 120, the flash controller 115 monitors flash memory devices 280₁ to 280ᵣ to determine if the flash devices are active (step 320). If an active flash memory device 280₁ to 280ᵣ is found (step 325), the flash controller 115 generates a command to retrieve device ID of the active flash memory device 280₁ to 280ᵣ (step 330). In case all of the flash memory devices 280₁ to 280ᵣ are inactive, the flash controller returns to step 320 to detect any change in the status of any of the flash memory devices 280₁ to 280ᵣ.

The flash controller 115 uses data signal lines 145 to detect the device ID of the active flash memory device 280₁ to 280ᵣ (step 330). The flash controller 115 utilizes logic available in the memory characteristic registers 240, in the state machine 135, or available through an external memory device to decode the flash memory device ID (step 335). The flash controller 115 provides information obtained from decoding the device ID to the state machine 135 and commands the state machine 135 to select an optimal ECC algorithm ECC-1 to ECC-k (128₁ to 128ₖ) (step 340). The flash controller 115 stores data of the selected ECC algorithm ECC-1 to ECC-k (128₁ to 128ₖ) and the corresponding flash memory devices 280₁ to 280ᵣ in memory table 120 at a specified memory location for future use (step 345). Storing data relating to the flash memory devices 280₁ to 280ᵣ and preferred corresponding ECC algorithms ECC-1 to ECC-k (128₁ to 128ₖ) enables the flash controller 115 to reduce the latency involved in encoding and decoding of data and also reduces the amount of power consumption.

State machine 135 generates a signal to select the preferred ECC algorithm ECC-1 to ECC-k (128₁ to 128ₖ) and also initiates the ECC controller 125 (step 350). Next, data is retrieved from memory interface 110 (step 353). The ECC controller 125 utilizes the selected ECC algorithm ECC-1 to ECC-k (128₁ to 128ₖ) and activates the appropriate encoder circuit 250 to encode data received from the memory interface 110 (step 355). The flash controller 115 writes the encoded data to the targeted flash memory device 280₁ to 280ᵣ using data signals 145 (step 360). The flash controller 115 verifies if more data need to be written to flash memory devices 280₁ to 280ᵣ after completing the write cycle (step 365). If more data need to be written, the flash controller 115 determines if new data need to be written to the last written flash memory device 280₁ to 280ᵣ (step 370). If no further data need to be written to the flash memory device 280₁ to 280ᵣ the flash controller 115 returns to the idle state (step 305) and detects if write control signal 140 is enabled. If data need to be written to the same flash memory device 280₁ to 280ᵣ (step 370), the flash controller 115 returns to step 353, step 355 and step 360 to retrieve, encode, and write data to the target flash memory device 280₁ to 280ᵣ. Otherwise the flash controller 115, at step 370, returns to step 315 and verifies if the information regarding the flash memory device 280₁ to 280ᵣ and the preferred ECC algorithm ECC-1 to ECC-k (128₁ to 128ₖ) is available in the memory table 120.

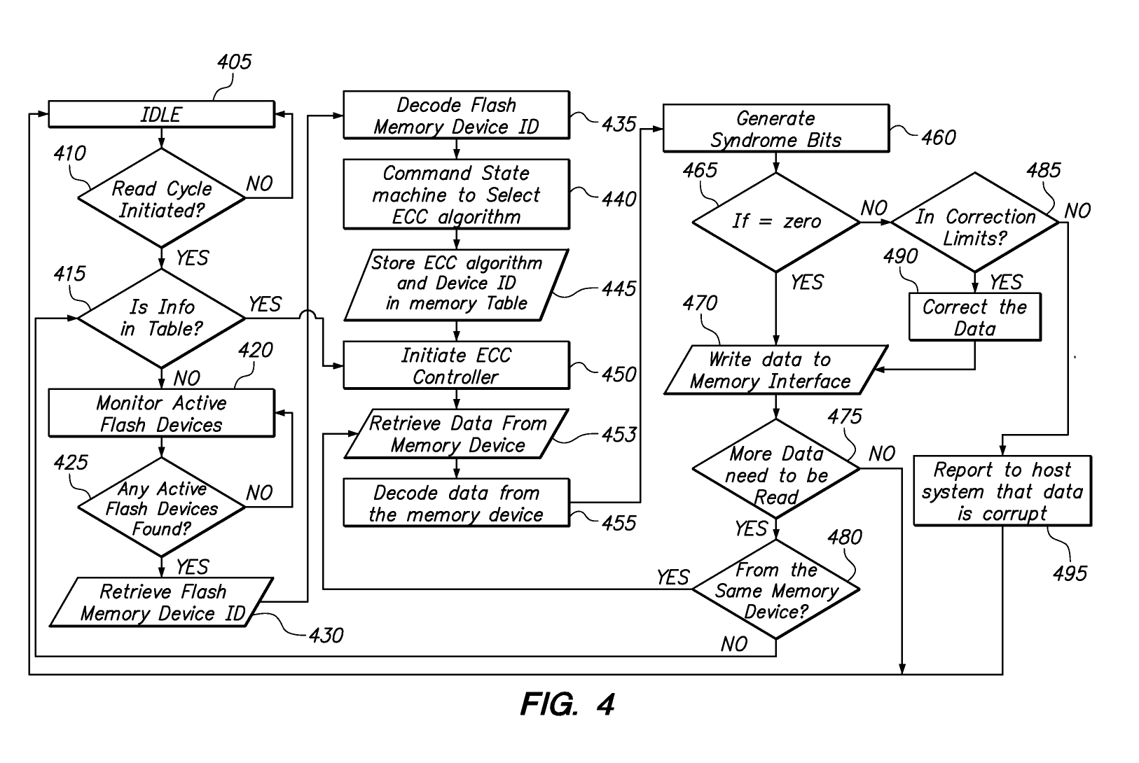

FIG. 4 illustrates the operation of the flash controller 115 in one embodiment where the flash controller 115 receives a command from the CPU 105 to read data from one of the flash memory devices 280₁ to 280ᵣ. On receiving power, the flash controller 115 can be programmed to operate in the idle state (step 405). The flash controller 115 determines if a read cycle is initiated by the CPU 105 on a timely basis (step 410). When the read cycle 410 is initiated by the CPU 105, the flash controller 115 determines if information regarding the flash memory device 280₁ to 280ᵣ and the preferred ECC algorithm ECC-1 to ECC-k (128₁ to 128ₖ) is available in the memory table 120 (step 415). If read cycle 410 is not initiated, the flash controller 115 remains in idle state (step 405). If information regarding the flash memory devices 280₁ to 280ᵣ, and the preferred ECC algorithm ECC-1 to ECC-k (128₁ to 128ₖ) is available in the memory table 120, then the flash controller 115 initiates the ECC controller 125 (step 450). If information is not available in memory table 120, flash controller 115 monitors the flash memory devices 280₁ to 280ᵣ to determine if the flash memory devices are active (step 420). In case of one of the flash memory devices 280₁ to 280ᵣ is active (step 425), the flash controller 115 generates a command to retrieve device ID of the active flash memory devices 280₁ to 280ᵣ (step 430). In case all of the flash memory devices 280₁ to 280ᵣ are inactive, the flash controller 115 returns to step 410 to detect any change in the status of any of the flash memory devices 280₁ to 280ᵣ (step 425). The flash controller 115 uses data signal lines 145 to retrieve the flash memory device ID of active flash memory device 280₁ to 280ᵣ (step 430). The flash controller 115 utilizes data available in the memory characteristic registers 240 either present in the state machine 135 or available through an external memory device to decode the flash memory device ID (step 435). The flash controller 115 provides the information obtained from decoding the device ID to the state machine 135 and commands the state machine to select an optimal ECC algorithm ECC-1 to ECC-k (128₁ to 128ₖ) (step 440). The flash controller 135 stores data of the selected ECC algorithm ECC-1 to ECC-k (128₁ to 128ₖ) and the corresponding flash memory device 280₁ to 280ᵣ in a memory table 120 at a specified memory location for future use (step 445).

Next, state machine 135 generates a signal to initiate ECC controller 125 (step 450) and execute the appropriate ECC algorithm ECC-1 to ECC-k (128₁ to 128ₖ). Next, data is retrieved from a memory device (step 453). The ECC controller 125 utilizes the selected ECC algorithm ECC-1 to ECC-k (128₁ to 128ₖ) and activates [**does it do more than activate decoder circuit? i.e., does decoder circuit execute ECC algorithm?**] the appropriate decoder logic circuit 255 to decode data received from the flash memory device 280₁ to 280ᵣ (step 455). The decoder logic circuit 255 generates syndrome bits to detect the presence of errors in data read from the flash memory device 280₁ to 280ᵣ (step 460). The syndrome bits are verified to detect any errors; if each syndrome bit is zero (step 465), then the decoder did not detect any errors, otherwise data received include errors.

If the decoder circuit 255 did not detect any errors, the data are written to memory interface 110 from the flash controller 115 (step 470). The flash controller 115 determines if more data need to be read from flash memory devices 280₁ to 280ᵣ (step 475). If no further data need to be read from the flash memory device 280₁ to 280ᵣ, the flash controller 115 returns to idle state (step 405). If more data need to be read, the flash controller 115 determines if new data need to be read from the last read flash memory device 280₁ to 280ᵣ (step 480). In case data need to be read from the same flash memory device, the flash controller 115 returns to step 453 to read and decode data from the target flash memory device 280₁ to 280ᵣ, otherwise the flash controller 115 returns to step 415 and verifies if the information regarding the flash memory devices 280₁ to 280ᵣ and the preferred ECC algorithm ECC-1 to ECC-k (128₁ to 128ₖ) is available in the memory table 120.

On other hand, if the decoder circuit 255 detects errors in data received from the flash memory devices, the flash controller 115 determines if the errors are within the correction limits of the ECC algorithm ECC-1 to ECC-k (128₁ to 128ₖ) (step 485). If the detected errors are within the correction limits of the ECC algorithm then the ECC controller 125 corrects the errors in data received from the flash memory devices 280₁ to 280ᵣ (step 490) and corrected data are written to memory interface 110 from the flash controller 115 (step 470). If the detected errors are not within the correction limits of the ECC algorithm, the flash controller 115 sends a notification to the host system that data received from the flash memory device 280₁ to 280ᵣ is corrupt (step 495) and returns to the idle state (step 405).

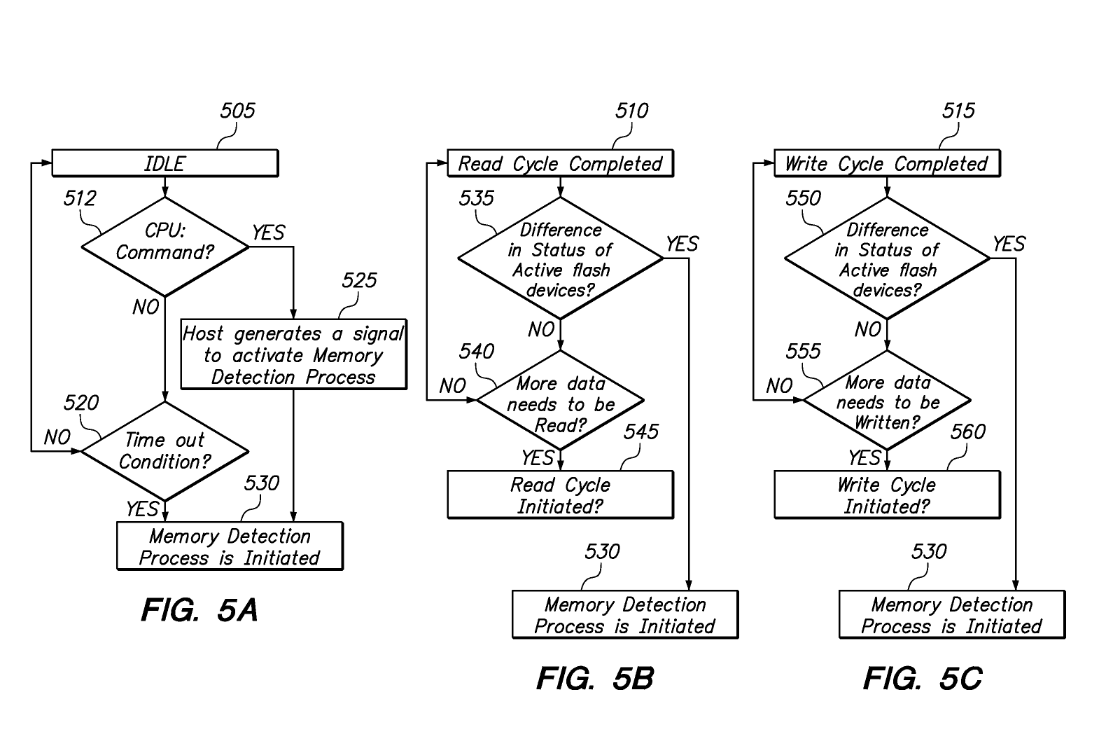

FIG. 5a illustrates the operation of the flash controller 115 in one embodiment where the flash controller 115 enables the flash memory device 280₁ to 280ᵣ detection process 530 on reaching timeout condition (step 520), receiving a command from the CPU 105 (step 512), or by monitoring the changes in the status of the active flash memory devices 280₁ to 280ᵣ. [**not shown?**] On receiving power, the flash controller 115 can be programmed to operate in idle state (step 505). CPU 105 may or may not issue a command (step 512). If not, flash controller 115 determines if the predetermined timeout condition is met (step 520), and, if so, the flash controller enables memory detection process 530. Otherwise, the flash controller 115 returns to the idle state (step 505). In one embodiment, the flash controller 115 verifies if the CPU 105 issued an activation command to initiate the memory detection process 525. In case of receiving an activation command, the flash controller 115 initiates the memory detection process 530, otherwise returning to the idle state (step 505).

FIG. 5b illustrates another embodiment, when the flash controller 115 enters read complete state after finishing reading data from one of target flash memory devices 280₁ to 280ᵣ (step 510). The flash controller 115 monitors the status of the flash memory devices 280₁ to 280ᵣ to detect any change (step 535). In case of no detectable change in the status of the flash memory devices 280₁ to 280ᵣ, flash controller 115 determines if more data need to be read from one of flash memory devices 280₁ to 280ᵣ (step 540), otherwise the flash controller 115 initiates memory detection process 530. Flash controller 115, on determining that more data need to be read from the flash memory device, activates the read cycle (step 545) and returns to step 510. If no other data need to be read, flash controller 115 returns to read complete state (step 510).

FIG. 5c illustrates another embodiment, when the flash controller 115 enters the write complete state after finishing writing data to the target flash memory devices 280₁ to 280ᵣ (step 515). The flash controller 115 monitors the status of the flash memory devices 280₁ to 280ᵣ (step 550) to detect any change. In case of no detectable change in the status of the flash memory devices 280₁ to 280ᵣ, the flash controller 115 determines if more data need to be written to the flash memory devices 280₁ to 280ᵣ (step 555), otherwise the flash controller 115 initiates the memory detection process (step 530). Flash controller 115, on determining that more data need to be read from [**written to?**] the flash memory device 280₁ to 280ᵣ, activates the write cycle and returns to step 510, otherwise returns to write complete state (step 560).

In one embodiment, memory detection process 530 involves monitoring the active flash memory devices 280₁ to 280ᵣ, detecting the flash memory device, and determining the characteristics of the flash memory device. For example, memory detection process 530 involves executing step 320, step 325, step 330, step 335, step 340 and step 340. Similarly, memory detection process 530 involves executing step 420, step 425, step 430, step 435, step 440 and step 440.

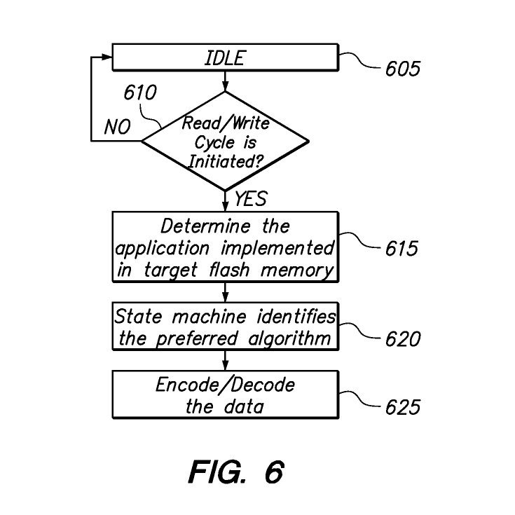

FIG. 6 illustrates the operation of the flash controller 115 in one embodiment where the flash controller selects the preferred ECC algorithm ECC-1 to ECC-k (128₁ to 128ₖ) based on the application of the target flash memory device. On receiving power, the flash controller 115 can be programmed to operate in the idle state (step 605). In one embodiment, the flash controller 115 determines if the read or write cycle is initiated. In case of the flash controller 115 not receiving either read or write signal, the process returns to the idle state (step 610). On receiving either a read or write command from the memory interface 110, flash controller 115 determines the application of the target flash memory device (step 615). The state machine 135 uses the information available in the memory table 120 or external information to determine the optimal ECC algorithm from table 128, ECC-1 to ECC-k (step 620). State machine 135 enables the ECC controller 125 and sends a command to decode or encode data using the identified ECC algorithm ECC-1 to ECC-k (128₁ to 128ₖ) prior to reading or writing to flash memory device (step 625).

Thus, the present invention provides a commercially advantageous system to detect and correct data errors during flash memory read and write cycles. Factors determining how robust an error correction routine is include the number of errors at a given instance, the current application, and the type of flash memory in use. Error detection and correction apparatus includes a controller having a memory table, a state machine, an error correction code controller, and a flash component interface. During read and write cycles, an error correction code algorithm, chosen in regard to the current application and the type of flash memory, monitors stored flash memory data, detects errors, and corrects flash memory data faults.

While the particular method and apparatus as herein shown and described in detail is fully capable of attaining the above-described objects of the invention, it is to be understood that it is the presently preferred embodiment of the present invention and is thus representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular means “at least one”. All structural and functional equivalents to the elements of the above-described preferred embodiment that are known or later come to be known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims.

We claim:

1. A method to choose and implement a mode of error detection and correction for a flash memory, comprising:
identifying a type of the flash memory,
selecting an error detection and correction algorithm associated with the type of the flash memory, and
executing the error detection and correction algorithm.

2. A method to choose and implement a mode of error detection and correction for a flash memory comprising:
identifying a type of the flash memory,
identifying an application algorithm associated with the flash memory,
selecting an error detection and correction algorithm associated with the type of flash memory and the application algorithm, and
executing the error detection and correction algorithm.

3. A system to choose and implement a mode of error detection and correction for a flash memory comprising:
flash memory identification circuits, the identification circuits being adapted to detect a
type of flash memory,
a processor coupled to the identification circuits, the processor adapted to select an error detection and correction algorithm associated with the type of flash memory, and
means for executing the error detection and correction algorithm.

4. A system to choose and implement a mode of error detection and correction for a flash memory comprising:
flash memory identification circuits, the identification circuits being adapted to detect a type of flash memory,
means for identifying an application algorithm associated with the flash memory,
a processor coupled to the identification circuits, the processor in communication with the means for identifying the application algorithm,
the processor adapted to select an error detection and correction algorithm associated with the type of flash memory and application algorithm, and
means for executing the error detection and correction algorithm.

5. A method to correct errors in data contained in a member of a plurality of memory devices, comprising:
associating one or more error correction algorithms with the memory devices,
selecting an error correction algorithm, from the error correction algorithms, associated with the member,
reading data from the member,
decoding data from the member after reading the data,
generating syndrome bits from the data after decoding the data,
executing the error correction algorithm to correct errors in the data if syndrome bits are nonzero and if the data can be corrected,
writing correct data to a memory interface if correct data available, otherwise reporting to a host system that data cannot be corrected.

6. The method of claim 5 wherein:
the member is a flash memory,
the plurality of memory devices are flash memories.

7. A method to write data to a member of a plurality of memory devices, comprising:
associating one or more error correction algorithms with the memory devices,
selecting an error correction algorithm, from the error correction algorithms, associated with the member,
retrieving the data from a memory interface,
executing the error correction algorithm to encode the data,
writing encoded data to the member.

8. The method of claim 7 wherein:
the member is a flash memory,
the plurality of memory devices are flash memories.
